(19) United States
(12) Patent Application Publication
(10) Pub. No.: US 2007/0170748 A1
(43) Pub. Date: Jul. 26, 2007

(54) VEHICLE HAVING A HARDTOP ROOF

(75) Inventor: Philipp Wolf, Stuttgart (DE)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Bietigheim-Bissingen (DE)

(21) Appl. No.: 11/548,891

(22) Filed: Oct. 12, 2006

(30) Foreign Application Priority Data
Oct. 12, 2005 (DE) 10 2005 049 339.4

(51) Int. Cl. B60J 7/00

(52) U.S. Cl. 296/108

(57) ABSTRACT

A roof for a vehicle includes rear and front roof parts. A kinematic roof mechanism adjusts the rear roof part between a closed position in which the rear roof part covers the rear seat region of the interior of a vehicle and a stored position in which the rear roof part is lowered relative to its closed position and forms a loading surface. The front roof part is articulately connected to the rear roof part to be adjustable between a closed position in which the front roof part is in front of the rear roof part and covers the front seat region of the vehicle interior and an opened position in which the front roof part exposes the front seat region of the vehicle interior.

### CROSS-REFERENCE TO RELATED APPLICATIONS

This application claims foreign priority benefits under 35 U.S.C. § 119(a)-(d) to DE 10 2005 049 339.4, filed Oct. 12, 2005, which is hereby incorporated by reference in its entirety.

### BACKGROUND OF THE INVENTION

1. Field of the Invention

The present invention relates to adjustable hardtop roofs for vehicles.

2. Background Art

Rinspeed AG, of Zumikon, Switzerland, introduced a vehicle under the trade name “Rinspeed Bedouin” at the 2003 Geneva Automobile Show. This vehicle includes a hardtop roof. The roof has multiple roof parts including rear and front roof parts. The front roof part is a solid roof part. The roof parts are adjustable between closed and stored positions. In the closed position, the roof parts form a conventional roof which covers the vehicle interior with the front roof part covering the region above the front seats of the vehicle. In the stored position, the roof parts are lowered relative to the closed position and the rear roof part forms a loading surface. This vehicle may be used either as a pickup vehicle having a covered driver cab or a sport vehicle having a roof which fully closes. A problem with this roof is that vehicle passengers experience a crowded feeling when the roof is in the stored position as much of the vehicle interior is used to accommodate the loading surface of the roof, thereby constricting the vehicle interior when the roof is stored.

### SUMMARY OF THE INVENTION

An object of the present invention is a vehicle hardtop roof movable to a stored position in which the roof is stored within the rear area of the vehicle interior and forms a loading surface and does not constrict the front driver-side region of the vehicle interior.

In carrying out the above object and other objects, the present invention provides a roof for a vehicle. The roof includes rear and front roof parts. A kinematic roof mechanism adjusts the rear roof part between a closed position in which the rear roof part covers the rear seat region of the interior of a vehicle and a stored position in which the rear roof part is lowered relative to its closed position and forms a loading surface. The front roof part is articulately connected to the rear roof part to be adjustable between a closed position in which the front roof part is in front of the rear roof part and covers the front seat region of the vehicle interior and an opened position in which the front roof part exposes the front seat region of the vehicle interior.

In an embodiment of the present invention, an adjustable hardtop roof for a vehicle includes front and rear roof parts. The front roof part is articulately connected to the rear roof part. The roof is movable via an intermediate position between a closed position and a stored position. In the closed position of the roof, the roof parts are both in closed positions such that the front roof part is in front of the rear roof part and the roof parts are vertically aligned with the roof level of the vehicle. In its closed position, the front roof part covers a front seat region of the vehicle interior. In the stored position of the roof, the rear roof part is in a loading position to form a loading surface. In its loading position, the rear roof part is vertically lowered with respect to the roof level of the vehicle. In the stored position of the roof, the front roof part is in an opened position and is positioned underneath a front region of the rear roof part. In its opened position, the front roof part is located below the rear roof part to thereby expose the front seat region of the vehicle interior.

In an embodiment of the present invention, an adjustable hardtop roof for a vehicle having support pillars includes front and rear roof parts. The roof is movable between a closed position and a stored position. In the closed position of the roof, the rear roof part is in a closed position and the front roof part is in either a closed position or an opened position. When both of the roof parts are in their closed positions, the front roof part is in front of the rear roof part and the roof parts are vertically aligned with the roof level of the vehicle. In the stored position of the roof, the rear roof part is in a loading position to form a loading surface and the front roof part is in its opened position. In its loading position, the rear roof part is vertically lowered with respect to the roof level of the vehicle.

In an embodiment of the present invention, the front roof part is articulately hinged to the rear roof part to be movable from a closed position in which the front roof part covers the front seat region of the vehicle interior to an opened position in which the front roof part is moved away from the front seat region of the vehicle interior to expose the front seat region. In this manner, a Targa vehicle or a convertible vehicle results when the front roof part is in its opened position depending upon whether the rear roof part is in its closed position or whether the rear roof part is in its loading position. When the rear roof part is in its loading position, the roof may be used as a loading surface. Although a portion of the vehicle interior behind the driver (i.e., behind the front seat region) stores the roof when the roof is in the stored position, the driver does not feel crowded as the vehicle interior is exposed above the front seat region.

In accordance with an embodiment of the present invention, an advantage is that it is possible for a convertible vehicle to transport bulky loads.

In an embodiment of the present invention, the roof includes a plurality of rigid roof parts. All or part of the roof parts are adjustable between a closed position and a stored position. In the stored position, one or more of the roof parts form a common loading surface.

In an embodiment of the present invention, the front roof part is mechanically coupled to a rear roof part and/or to a kinematic roof mechanism such that the front roof part is automatically transferred from its closed position to its opened position as soon as the other roof parts have moved to their loading position (i.e., as soon as the roof is moved to its stored position). Alternatively, the front roof part is moved from its closed position to its opened position independently of the other roof parts. In this case, the front seat region of the vehicle is exposed when the roof is otherwise closed.

In an embodiment of the present invention, the front roof part is hinged to a rear roof part. Preferably, the front roof part is hinged to the rear roof part which forms the loading surface. In this manner, it is possible to move the front roof part together with other roof parts of the roof. In particular, in this manner, it is possible to move the front roof part together with the rear roof part(s) which form the loading surface.

In an embodiment of the present invention, a four-bar kinematic linkage hinges the front roof part to a rear roof part which forms the loading surface. The front roof part may thus be moved from its closed position to its opened position along a combined rotational and translational adjustment motion. In particular, the front roof part in its opened position may be positioned underneath and parallel to the rear roof part which is articulately connected thereto. As a result, the least possible storage space is required for the roof in its stored position and wind resistance is minimized when the rear roof part(s) are in their closed position and the front roof part is in its opened position.

In an embodiment of the present invention, at least one rear roof part (and preferably all of the rear roof parts) may be lifted with respect to its closed position together with the front roof part. Advantageously, at least all of the roof parts articulately connected to the front roof part, in particular at least the roof parts which form the loading surface, are liftable with respect to the closed position of the roof. Advantageously the roof part(s) which are liftable with respect to the closed position of the roof are additionally moved in the direction of the rear of the vehicle relative to the closed position of the roof part(s). In this manner, space is provided for a swivel motion of the front roof part from its closed position to its opened position. In particular, as a result of lifting at least one rear roof part, the front roof part may swivel below the adjacent rear roof part without endangering vehicle occupants or colliding with vehicle components such as the front seat backs. It is possible to swivel the front roof part below an adjacent rear roof part without providing lifting or swiveling capability in the rear direction for the remaining rear roof parts. In this case, however, the distance of the front roof part from vehicle parts situated below or next to same, such as the seat backs of the front seats, are selected to be great enough to avoid a collision, or the collision-endangered vehicle components are swivelable from their collision position to clear the path for a swivel motion of the front roof part below an adjacent rear roof part. It is advantageous for the lifted roof part to be uniformly aligned in the lifted position, preferably at least approximately horizontally aligned, such as in its closed position. For this purpose, the roof part that is to be lifted is hinged to the vehicle body such that the roof part undergoes a rotational-translational motion.

The swiveling of the front roof part below an adjacent rear roof part has the advantage that the space requirements for the front roof part in its opened position are minimal. The front roof part preferably swivels below an adjacent rear roof part during or after the lifting motion of the adjacent rear roof part from its closed position, and/or during or after the swiveling of the adjacent rear roof part in the rear direction. In an embodiment of the present invention, the rear roof part which forms the loading surface may be moved into its lowered stored position together with the front roof part. This is practical for a configuration in which the front roof part is swivelled below the rear roof part. In this case, the loading surface is not diminished by the front roof part, which is situated below the rear roof part.

In an embodiment of the present invention, the vehicle includes a tailgate hinged to the vehicle body to allow the trunk of the vehicle to be loaded when the roof is in its closed position. The tailgate is inwardly foldable into the vehicle to provide space for the roof in its stored position. The tailgate in its lower region may be hinged to the vehicle body and foldable by approximately 90° into the vehicle interior. A rear roof part, preferably a section of the roof part which forms the loading surface, is advantageously curved or angled downward. The curved or angled section of the downwardly pointing rear roof part forms a rear closure for the vehicle and covers the rear region behind the tailgate.

In an embodiment of the present invention, the front roof part in its opened position is swiveled upward relative to its closed position by at least 90° or by at least 100°. The swivel axis is situated such that the portion of the front roof part oriented in the direction of travel points upward. For the case that the front roof part together with the rear roof part which forms the loading surface is lowerable into a stored position, the upwardly pointing front roof part may be used as the front boundary of the loading surface. The front roof part then forms a boundary between the front seat region which is open at the top and the loading region of the vehicle situated behind same. In addition, the front roof part assumes the function of a windbreak behind the front seats, or behind the auxiliary seats if present.

In an embodiment of the present invention, to improve the windbreak function, the length of the front roof is variable. To this end, the front roof part has an extendable element such as an extendable panel. This extension may be achieved when the front roof part is swivelled about a swivel axis relative to its closed position and is moved, together with the other roof parts, into the stored position of the roof. In this manner, the windbreak function is improved as the extension of the front roof part is increased in the vertical direction thereby keeping air turbulence out of the cockpit region of the vehicle interior.

In an embodiment of the present invention, at least the rear roof part which forms the loading surface is situated in the stored position of the roof above the rear wheel housings. The loading surface is thus able to extend over practically the entire width of the vehicle. Recesses in the loading surface for the wheel housings may not be present.

The roof parts may be designed such that the loading surface is aligned at least approximately horizontally.

The front roof part in its opened position may not be used as a windbreak and/or loading surface boundary, but instead be part of the loading surface. In this manner, the loading surface may be enlarged to a maximum available space.

In an embodiment of the present invention, the loading surface is formed by the upper side (in the closed position) of the roof part which forms the loading surface. This allows the use of a kinematic roof mechanism having a relatively simple design as in the simplest case it is not necessary to rotate the roof parts.

To increase the rigidity of the vehicle body, at least the roof part which forms the loading surface is laterally lockable to the vehicle body when the roof is in its stored position. For this purpose, locking hooks by which the roof parts are laterally pulled to the vehicle body and thus firmly clamped may be used.

In an embodiment of the present invention, the roof has just two movable roof parts. These roof parts include a front roof part and a rear roof part. The rear roof part forms the loading surface.

So that the loading surface is particularly robust and damage from transported loads is avoided, the surface of the roof part which forms the loading surface is advantageously provided with a hard, in particular scratch-resistant, coating.

In an embodiment of the present invention, stationary, non-swivelable pillars such as C-pillars extending essentially in the vertical direction are provided in the rear region of the vehicle. At least a portion of the roof may be moved relative to the C-pillars between the closed position and the stored position in which the loading surface is formed. When the roof is in its stored position, the support pillars provide rollover protection for ensuring the safety of vehicle occupants when the front roof part is in its opened position.

Between the support pillars a rear window may be provided which is retracted or retractable, at least in the stored position of the roof parts. In this manner, loads may be introduced on the loading surface through the back side of the vehicle between the support pillars. Loaded articles may also project beyond the rear boundary of the vehicle.

To optimize the rollover function of the support pillars, the support pillars are connected in their upper region via a transverse brace.

The above features, and other features and advantages of the present invention are readily apparent from the following detailed descriptions thereof when taken in connection with the accompanying drawings.

### BRIEF DESCRIPTION OF THE DRAWINGS

FIG. 1 illustrates an adjustable hardtop roof in accordance with a first embodiment of the present invention with the roof being in a closed position;

FIG. 2 illustrates the roof in accordance with the first embodiment of the present invention with the roof being in an intermediate position;

FIG. 3 illustrates the roof in accordance with the first embodiment of the present invention with the roof being in a stored position and the front roof part of the roof being in an opened position;

FIG. 4 illustrates an adjustable hardtop roof in accordance with a second embodiment of the present invention with the roof being in a closed position;

FIG. 5 illustrates the roof in accordance with the second embodiment of the present invention with the front roof part of the roof being in an opened position;

FIG. 6 illustrates the roof in accordance with the second embodiment of the present invention with the roof having a kinematic roof mechanism designed as a hydraulic cylinder;

FIG. 7 illustrates the roof in accordance with the second embodiment of the present invention with the roof having a kinematic roof mechanism designed as a scissor bar linkage system;

FIG. 8 illustrates the roof in accordance with the second embodiment of the present invention with the roof being in a stored position and the rear roof part forming a loading surface;

FIG. 9 illustrates a perspective view of the roof in accordance with the second embodiment of the present invention with the roof in a stored position and a front roof part of the roof being designed as a windbreak; and

FIG. 10 illustrates a perspective rear view of the stationary C-pillars of the vehicle in accordance with the second embodiment of the present invention.

### DETAILED DESCRIPTION OF THE PREFERRED EMBODIMENT(S)

Like components have like reference numerals in the Figures.

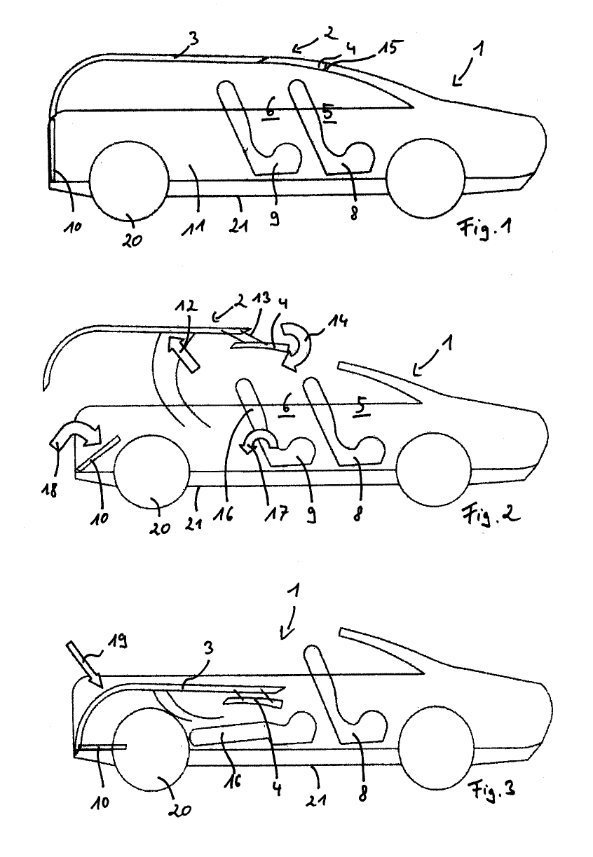

Referring now to FIGS. 1, 2, and 3, an adjustable hardtop roof 2 for a vehicle 1 in accordance with a first embodiment of the present invention is shown. Vehicle 1 includes a tailgate 10 which in its lower region is hinged to vehicle body 11. Roof 2 includes a plurality of rigid roof parts. In this embodiment, roof 2 includes a rear roof part 3 and a front roof part 4. Front roof part 4 is articulately connected to rear roof part 3. Rear roof part 3 generally has a larger surface area than front roof part 4.

In general, roof 2 is movable between a closed position and a stored position. In the closed position of roof 2, roof parts 3, 4 are both in closed positions such that front roof part 4 is in front of rear roof part 3 and roof parts 3, 4 are vertically aligned with the roof level of vehicle 1. In the stored position of roof 2, rear roof part 3 is in a loading position to form a loading surface. In its loading position, rear roof part 3 is vertically lowered with respect to the roof level of vehicle 1. That is, in its loading position, rear roof part 3 is vertically lowered relative to its closed position. In the stored position of roof 2, front roof part 4 is in an opened position and is positioned underneath a front region of rear roof part 3.

FIG. 1 illustrates roof 2 in its closed position. In the closed position of roof 2, roof parts 3, 4 are in their respective closed positions such that roof parts 3, 4 horizontally extend over interior 6 of vehicle 1 and cover vehicle interior 6. Particularly, front roof part 4 is located in front of rear roof part 3 along the forward direction of vehicle travel. Roof parts 3, 4 are both vertically aligned with the roof level of vehicle 1. Front roof part 4 is locked to a windshield frame 15 of vehicle 1. Front roof part 4 covers a front seat region 5 of vehicle interior 6. Front seats 8 and rear seats 9 in vehicle interior 6 are fully usable when roof 2 is in its closed position as shown in FIG. 1. Vehicle interior 6 may include narrower auxiliary seats instead of or in addition to rear seats 9.

FIG. 2 illustrates roof 2 in an intermediate position between its closed and stored positions. In the intermediate position of roof 2, roof parts 3, 4 are vertically lifted with respect to the roof level of vehicle (i.e., roof parts 3, 4 are raised relative to their closed positions and roof 2 is raised relative to its closed position) and are swivelled along a rearward direction of vehicle travel. Upward and rearward pointing arrow 12 indicates the change in position of roof 2 in its intermediate position relative to its closed position. A kinematic roof mechanism (not shown) is operable with roof 2 to move roof parts 3, 4 along the direction of arrow 12. A four-bar kinematic linkage 13 articulately connects (i.e., hinges) front roof part 4 to rear roof part 3. In the intermediate position of roof 2 in which roof parts 3, 4 are lifted, front roof part 4 further undergoes via kinematic linkage 13 a combined rotational and translational motion underneath rear roof part 3 in the rearward direction of vehicle 1. Arrow 14 represents this swivel motion of front roof part 4 relative to rear roof part 3.

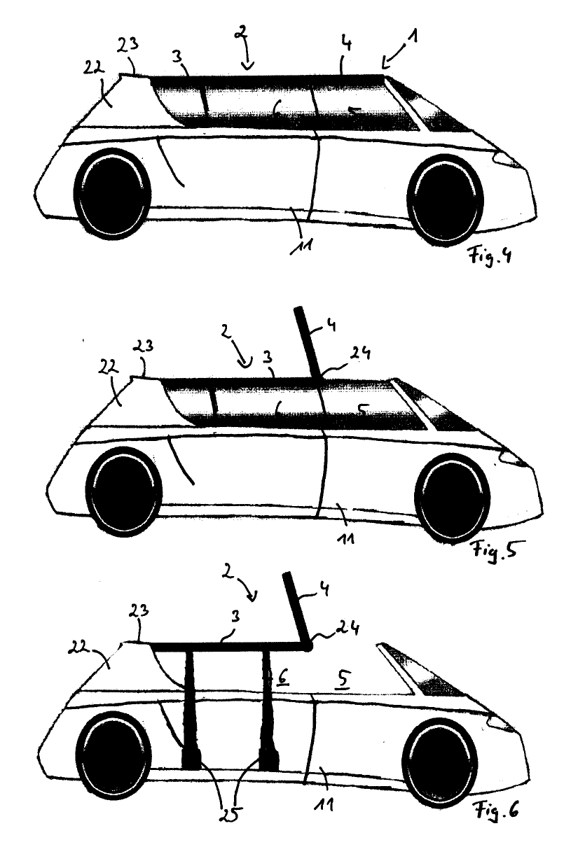

FIG. 3 illustrates roof 2 in its stored position. To enable roof 2 to swivel from its intermediate position to its stored position, seat backs 16 of rear seats 9 are initially folded backwards in a counterclockwise direction toward the rear direction of vehicle travel. Arrow 17 indicates the folding motion of seat backs 16 of rear seats 9. Folded seat backs 16 assume an essentially horizontal position when roof 2 is in its stored position. Further, to enable roof 2 to swivel from its intermediate position to its stored position, tailgate 10 is folded about swivel joints towards vehicle interior 6 as shown in FIG. 2 to provide space for roof 2. Arrow 18 in FIG. 2 indicates the folding motion of tailgate 10.

After or during the folding motions of tailgate 10 and rear seat backs 16, roof parts 3, 4 are mutually lowered into the stored position of roof 2 shown in FIG. 3. For this purpose, roof 2 is moved in the forward direction of vehicle travel and is moved vertically downward. It is possible that rear roof part 3 initially moves back to its closed position followed by a linear downward motion of rear roof part 3 together with front roof part 4. It is also possible that roof 2 to be moved in the forward direction of vehicle travel during the entire lowering motion. Arrow 19 in FIG. 3 indicates the resulting motion of roof 2 from its intermediate position to its stored position. In the stored position of roof 2, rear roof part 3 is in its loading position and forms a loading surface. As rear roof part 3 is situated above rear wheels 20 of vehicle 1, recesses in rear roof part 3 for wheel housings may be omitted. In the stored position of roof 2, front roof part 4 is located below a front region of rear roof part 3 and is essentially parallel thereto. As a result, the storage space requirements for front roof part 4 are minimal. The region above front seats 8 is exposed as front roof part 4 is swivelled about rear roof part 3 from its closed position to its opened position.

As shown in FIG. 3, vehicle 1 is a convertible vehicle having a loading surface. Rear roof part 3 in its larger front section is aligned essentially horizontally. In its rear region, rear roof part 3 is angled in the direction of vehicle floor 21, thereby forming a rear closure for vehicle 1.

Referring now to FIGS. 4, 5, 6, 7, 8, 9, and 10, with continual reference to FIGS. 1, 2, and 3, an adjustable hardtop roof 2 for a vehicle 1 in accordance with a second embodiment of the present invention is shown. In general, roof 2 in accordance with the second embodiment of the present invention is movable between a closed position and a stored position. In the closed position of roof 2, rear roof part 3 is in a closed position and front roof part 4 is in either a closed position or an opened position. When both of roof parts 3, 4 are in their closed positions, front roof part 4 is in front of rear roof part 3 and roof parts 3, 4 are vertically aligned with the roof level of vehicle 1. In the stored position of roof 2, rear roof part 3 is in a loading position to form a loading surface and front roof part 4 is in its opened position. In its loading position, rear roof part 3 is vertically lowered with respect to the roof level of vehicle 1.

Vehicle 1 in accordance with the second embodiment includes support pillars (C-pillars) 22. Support pillars 22 are oppositely situated apart from one another in the transverse direction of vehicle 1 and assume the function of a rollover bar. In the second embodiment, in addition to roof parts 3, 4, roof 2 includes a non-adjustable rear end roof part 23.

As shown in FIG. 10, rear end roof part 23 connects the top sides of support pillars 22 to one another resulting in a crossbar extending in the transverse direction of vehicle 1.

FIG. 4 illustrates roof 2 in its closed position. FIG. 5 illustrates front roof part 4 in its opened position. As described, front roof part 4 is directly hinged to rear roof part 3. Front roof part 4 swivels about a swivel axis 24 into its opened position. Compared to its closed position illustrated in FIG. 4, front roof part 4 swivels about 100° in the counterclockwise direction to thereby expose front seat region 5 of vehicle interior 6.

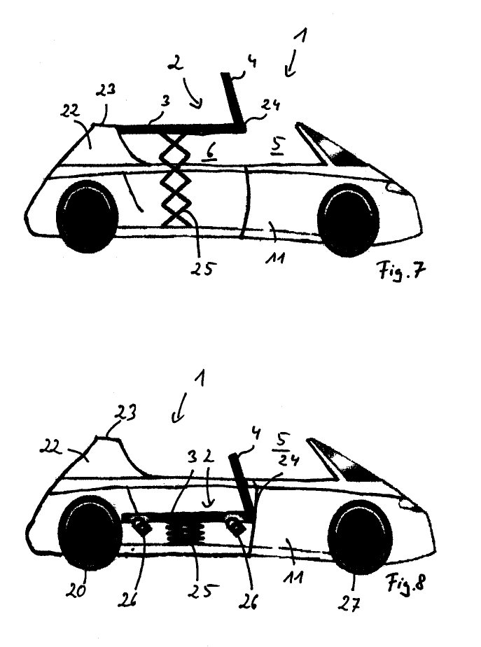

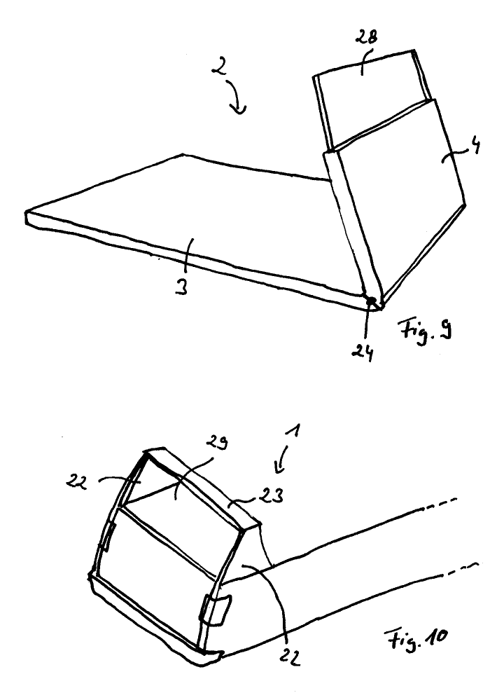

As shown in FIG. 6, a kinematic roof mechanism 25 is operable to move roof 2 between its closed and stored positions. Kinematic roof mechanism 25 includes hydraulic cylinders separated at a distance from one another. Via kinematic roof mechanism 25, rear roof part 3 together with front roof part 4 in its opened position may be linearly moved between the closed and stored positions of roof 2. FIG. 8 illustrates the stored position of roof 2. Rear roof part 3 together with front roof part 4 in its opened position are vertically lowered to place roof 2 in its stored position. Rear seat backs present within vehicle interior 6 are folded down before or during this lowering motion.

As shown in FIG. 7, kinematic roof mechanism 25 for performing the linear motion of roof 2 between its closed and stored positions may be designed as a scissor bar kinematic linkage.

As shown in FIG. 8, in the stored position of roof 2, rear roof part 3 forms a loading surface. The raised front roof part 4 which has been swivelled into its opened position assumes two functions. First, front roof part 4 serves as a front loading surface boundary and prevents loads from sliding into the front seat region 5 during braking. Second, front roof part 4 serves as a windbreak thereby increasing driver comfort by minimizing road noise.

Two locks 26 represent the locking of rear roof part 3 to vehicle body 11 in the stored position of roof 2. In this manner, the rigidity of the entire vehicle body 11 is increased.

In the stored position of roof 2 as illustrated in FIG. 8, rear roof part 3 is situated below the upper edge of rear wheels 20 and between rear wheels 20 and front wheels 27. In the stored position of roof 2, rear support pillars 22 together with the connecting rear end roof part 23 of roof 2 assume the function of a rollover bar and protect persons sitting in front seat region 5 of vehicle interior 6. In this embodiment, both the driver and the passenger have an unobstructed view of the loading surface.

FIG. 9 illustrates a perspective view of roof 2 in its stored position. The large, horizontal, rear roof part 3 and front roof part 4 situated at an angle of approximately 80° thereto can be seen. Front roof part 4 is swivelled about swivel axis 24 by approximately 100° relative to the closed position of front roof part 4 as illustrated in FIG. 4. The swivel axis is situated between rear roof part 3 and front roof part 4. A panel 28 may extend out from front roof part 4 to improve the windbreak function of front roof part 4 in the stored position of roof 2. Panel 28 has a transparent design so that the view of the loading surface, formed by rear roof part 3, by persons in front seat region 5 is not obstructed.

FIG. 10 illustrates vehicle 1 in a perspective view from the rear. A lowerable rear window 29 is between support pillars 22 which in particular is lowered in the stored position of roof 2 so that the loading surface may be loaded from the rear end of vehicle 1. It is possible for the loading surface to terminate in a planar manner flush with the lower edge of the rear window frame.

### LIST OF REFERENCE NUMERALS

1 Vehicle
2 Roof
3 Rear roof part
4 Front roof part
5 Front seat region
6 Vehicle interior
8 Front seats
9 Rear seats
10 Tailgate
11 Vehicle body
12 Arrow
13 Four-bar kinematic linkage
14 Arrow
15 Windshield frame
16 Seat back
17 Arrow
18 Arrow
19 Arrow
20 Rear wheels
21 Vehicle floor
22 Support pillars
23 Rear end part
24 Swivel axis
25 Kinematic roof mechanism
26 Locks
27 Front wheels
28 Panel
29 Rear window

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A roof for a vehicle, the roof comprising:
a rear roof part;
a front roof part; and
a kinematic roof mechanism for adjusting the rear roof part between a closed position in which the rear roof part covers the rear seat region of the interior of a vehicle and a stored position in which the rear roof part is lowered relative to its closed position and forms a loading surface;
wherein the front roof part is articulately connected to the rear roof part to be adjustable between a closed position in which the front roof part is in front of the rear roof part and covers the front seat region of the vehicle interior and an opened position in which the front roof part exposes the front seat region of the vehicle interior.

2. The roof of claim 1 wherein:
the adjustment motion of the rear roof part between its closed and stored positions and the adjustment motion of the front roof part between its closed and opened positions are mechanically coupled.

3. The roof of claim 1 wherein:
the front roof part is hinged to the rear roof part.

4. The roof of claim 3 further comprising:
a four-bar kinematic linkage, wherein the four-bar kinematic linkage hinges the front roof part to the rear roof part.

5. The roof of claim 1 wherein:
the kinematic roof mechanism vertically lifts the rear roof part together with the front roof part to an intermediate position when adjusting the rear roof part between its closed and stored positions.

6. The roof of claim 5 wherein:
the kinematic roof mechanism adjusts the rear roof part together with the front roof part in a rearward direction of the vehicle when vertically lifting the rear roof part together with the front roof part to the intermediate position.

7. The roof of claim 1 wherein:
the front roof part in its opened position is positioned below the rear roof part.

8. The roof of claim 1 wherein:
the rear roof part together with the front roof part are lowered when the rear roof part is adjusted to its stored position.

9. The roof of claim 1 wherein:
the rear roof part is adjusted between its closed position and its stored position along a linear motion.

10. The roof of claim 1 wherein:
the front roof part in its opened position is swivelled upward relative to its closed position about a swivel axis at least 90°.

11. The roof of claim 1 wherein:
the front roof part in its opened position is swivelled upward relative to its closed position about a swivel axis at least 100°.

12. The roof of claim 1 wherein:
the front roof part in its opened position forms a front boundary of the loading surface formed by the rear roof part.

13. The roof of claim 1 wherein:
the front roof part has an extendible length.

14. The roof of claim 1 wherein:
the rear roof part is situated in its stored position above rear wheel housings of the vehicle.

15. The roof of claim 1 wherein:
the rear roof part extends horizontally in its stored position.

16. The roof of claim 1 wherein:
the front roof part in its opened position is part of the loading surface formed by the rear roof part.

17. The roof of claim 1 wherein:
the rear roof part is laterally lockable to the vehicle by locking hooks when the rear roof part is in its stored position.

18. The roof of claim 1 wherein:
the rear roof part is coated with at least one of metal and plastic.

19. The roof of claim 1 wherein:
the vehicle includes vertically extending stationary pillars in the rear region of the vehicle.

20. The roof of claim 19 wherein:
the support pillars are connected in their upper region to a rear end roof part connected to the rear roof part.
